(19) United States
(12) Patent Application Publication
(10) Pub. No.: US 2005/0283387 A1
(43) Pub. Date: Dec. 22, 2005

(54) System for providing an interactive anatomical graphical representation of a body for use in a health care environment

(75) Inventors: Daniel J. Donoghue, Oregon, WI (US); James Ferris, Madison, WI (US); Handy Patriawan, Madison, WI (US); Steven J. Larsen, Cross Plains, WI (US); Christopher C. Spotts, McFarland, WI (US); Christopher J. Alban, Madison, WI (US); Mark Duane Buttner, Middleton, WI (US)

Correspondence Address: GODFREY & KAHN S.C., 780 NORTH WATER STREET, MILWAUKEE, WI, 53202, US

(73) Assignee: Epic Systems Corporation

(21) Appl. No.: 11/120,486

(22) Filed: May 3, 2005

Related U.S. Application Data
(63) Continuation-in-part of application No. 11/075,614, filed on Mar. 9, 2005.
(60) Provisional application No. 60/581,866, filed on Jun. 21, 2004.

(51) Int. Cl. G06Q 10/00

(52) U.S. Cl. 705/3; 705/2

(57) ABSTRACT

Disclosed is a system and method for providing a comprehensive interactive anatomical graphical representation of a body for use in a health care environment. The system comprises a health care information system having at least one data repository for storing data and at least one graphical user interface in communication with the at least one data repository, and at least one anatomical map of a body stored in the health care information system and displayable by the graphical user interface for managing care. Because the graphical representation of the at least one anatomical map of a body is integrated within the enterprise health care information system, it allows a user to access patient data and health care facility resource data, perform actions on the displayed patients and health care facility resources, and manage patient care and health care facility resources.

### CROSS-REFERENCE TO RELATED APPLICATION

This application is based on and claims the benefit of U.S. Provisional Application No. 60/581,866, filed on Jun. 21, 2004, and is a Continuation-in-Part of U.S. application Ser. No. 11/075,614, filed on Mar. 9, 2005.

### BACKGROUND OF THE INVENTION

The present invention relates generally to health care management and health care facility resource management, and more particularly, to a system and method for an interactive anatomical graphical representation of a body for managing patient care and health care facility resources.

Health care facilities provide for patient care. To provide patient care, it is necessary to maintain many types of information for patients. Access to this information is typically provided through a variety of software applications, usually related to the type of service being performed. In addition to providing patient care, health care facilities must manage many aspects of patient care. For example, health care facilities must keep track of patient admissions, discharges and transfers, appointment and procedure scheduling, billing and insurance information, and patient location and status. To effectively manage all aspects of patient care, health care facilities currently use a wide variety of health care management systems. Traditional health care management systems include paper charts and manually updated display boards. Recent upgrades in health care management systems include electronic systems that store, display, and facilitate the management of patient data. Most of these systems display information in a tabular format, but some include a display formatted to show patient room or bed locations. One such electronic system is disclosed in U.S. Patent Publication No. 2003/0074222, published Apr. 17, 2003. However, this system is limited to managing patient bed assignments and bed occupancy levels in a health care facility.

There are several limitations associated with these centralized bed management systems. First, the tabular displays are not very intuitive, especially to users who are new to a health care facility or new to health care management systems. A display showing a graphical representation of a patient or a map of the health care facility is more intuitive and easier to use. The prior art electronic systems that do have the capability of showing patient room or bed locations are also limited. Typically, those systems do not show an accurate graphical representation or map of the actual health care facility, but instead show a generic graphical representation of a typical facility.

Current systems also do not typically include graphical representations of a patient's body or parts of a patient's body. Also, the prior art systems are not able to track patients through the health care facility. Another significant limitation of the prior art systems is the fact that users cannot perform health care management actions on patients from the graphical representation or map display, such as admitting, discharging and transferring patients, assigning medical treatment teams to patients, scheduling patient appointments, ordering patient medications, documenting information about a patient's condition, and entering patient demographic, billing or insurance information. These actions must typically be performed using one or more separate health care management software applications.

Given the limitations and problems associated with the prior art systems and methods described above, there exists a need for an improved health care management system that is able to display an accurate anatomical graphical representation of a patient's body or part thereof for managing patient care and health care facility resources by allowing users to perform health care management actions on patients without moving between separate software applications. The present invention provides improvements over the prior art systems and methods described above, and provides solutions to problems raised or not solved thereby.

### SUMMARY OF THE INVENTION

The present invention provides a system and method for providing a comprehensive interactive anatomical graphical representation of a body for use in a health care environment. The system comprises a health care information system having at least one data repository for storing data and at least one graphical user interface in communication with the at least one data repository, and at least one anatomical map of a body stored in the health care information system and displayable by the graphical user interface for managing care.

The graphical representation preferably provides the ability to display patient data, and preferably is used for performing actions on the anatomical map displayed in the graphical representation. A user can also preferably selectively access, analyze and display patient data, and document information about a patient by writing directly on the graphical representation through the use of a writable display. The graphical representation further preferably includes visual indicators and visual alerts to represent certain identifiable and customizable characteristics or status indicators.

The present invention has several advantages over prior art systems and methods. For example, the graphical representation of the present invention is more intuitive, allowing users to see the data they need in a more efficient manner. The more intuitive graphical representation also makes the interactive map system easier to learn and operate, especially for those who are new to the interactive map system. Another advantage of the present invention is the ability to perform tasks or health care management actions directly from the interactive map, eliminating the need to switch to one or more separate systems. The present invention allows users to perform actions like, among others, updating patient status, documenting information about patient conditions, admitting, transferring and discharging patients, assigning treatment teams to patients, ordering patient medications and patient procedures, and entering and updating patient demographic, billing and insurance information.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram of an enterprise health care information system in accordance with an embodiment of the present invention.

FIG. 2 is a graphical representation of an anatomical interactive map of a human body in accordance with one embodiment of the present invention; and

FIG. 3 is a graphical representation of a surgical health care facility showing a patient in a bed in accordance with one embodiment of the present invention.

### DETAILED DESCRIPTION OF THE INVENTION

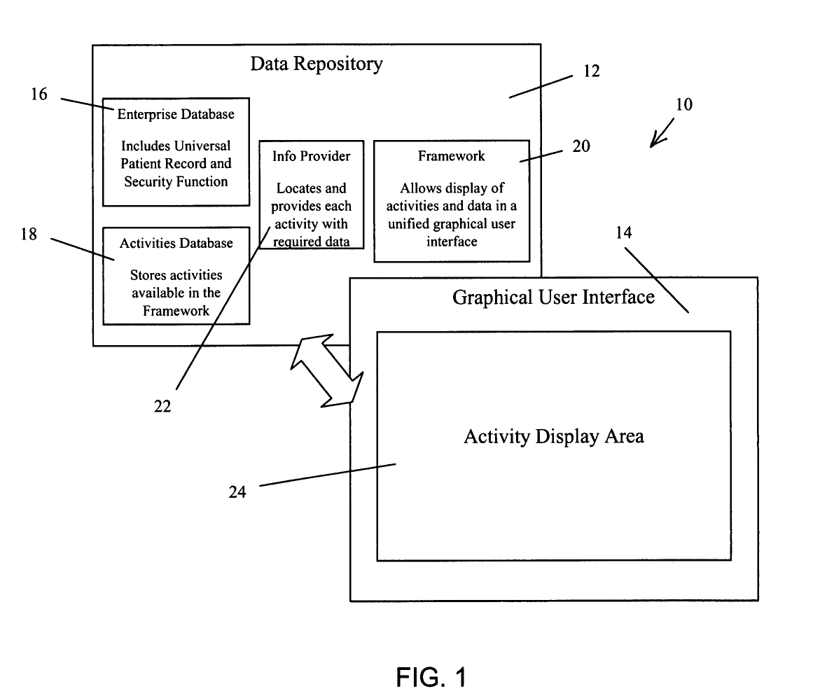

Referring now to the drawings, FIG. 1 is a block diagram of an enterprise health care information system 10 of the present invention. The enterprise health care information system 10 provides integration of health care records and health care records management, and facilitates access to health care records in a health care environment. The enterprise health care information system preferably comprises a plurality of integrated software applications and allows users to move between the plurality of software applications.

The integrated enterprise health care information system 10 preferably includes at least one data repository 12 for storing data and at least one graphical user interface 14 for accessing data. The data repository 12 is in communication with the graphical user interface 14. The data repository 12 preferably stores information related to system users and patients, including an enterprise database 16 with a universal patient record having data collected for each patient and security functions defining security parameters for system users, and an activities database 18. The universal patient record preferably includes information related to health care delivery for a patient, and information related to health care delivery management for the patient. System users have access to the universal patient record through one or more user interfaces in communication with the universal patient record. The security functions provide the ability to limit access to patient data displayable in the graphical representation of the health care facility and provide the ability to enable/disable actions performable on patients and health care facility resources displayable in the graphical representation of the health care facility. The data repository 12 further includes a modular framework 20 for supporting a plurality of patient care and health care facility resource management activities and an information provider 22 for providing each activity with its required data in communication with each other, and in communication with the enterprise database 16 and the activities database 18 which stores a plurality of activities for providing various aspects of patient care. These activities include, but are not limited to, activities used in providing health care to a patient and activities used in managing the health care provided to the patient.

The graphical user interface 14 provides a user access to the enterprise health care information system 10. The graphical user interface 14 displays information corresponding to one or more of the above-mentioned activities, and includes a common menu format for communicating available aspects in the graphical user interface, and common visual components for displaying information to the system user in an activity display area 24.

The enterprise health care information system 10 is designed to manage all aspects of a patient's health care including complete clinical, financial, and operational data relating to the patient through the use of the framework 20 for supporting a plurality of health care management activities that are stored in the activities database 18. Each health care management activity is preferably designed to manage a specific aspect of patient care. The framework 20 is preferably an integrated modular framework that allows users to easily move from one health care management activity to another using the information provider 22 in communication with the enterprise database 16 and the activities database 18.

In a preferred embodiment of the invention, the graphical user interface 14 comprises a display area 24 for displaying a graphical representation of at least one patient body or part thereof. The graphical representation is preferably an interactive map of the at least one patient body or part thereof stored in the data repository 12. Because the graphical representation of the at least one patient body or part thereof is integrated within the enterprise health care information system 10, it allows a user to visually locate patient wound and other status and condition information, provide access to patient data and health care facility resource data, perform actions on the anatomical map, and manage patient care and health care facility resources.

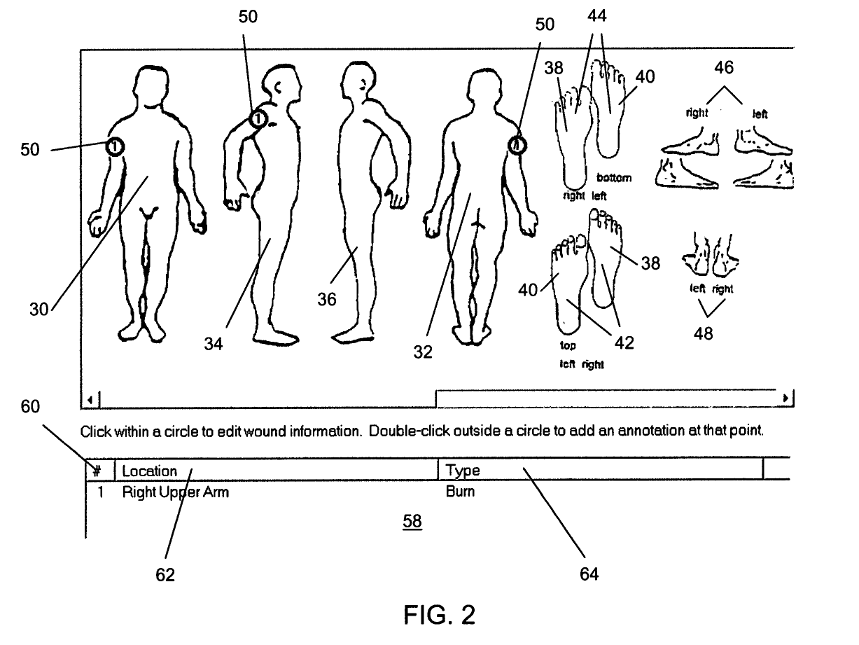

FIG. 2 is a graphical representation of an anatomical interactive map of the human body in accordance with one embodiment of the present invention. In FIG. 2, the interactive map is used to identify the location of a wound on a patient's body, and shows front 30, rear 32, right 34 and left 36 side graphical representations of a patient's body as well as right 38, left 40, top 42, bottom 44, side 46 and rear 48 graphical representations of a patient's feet. Graphical representations of any parts of the human body could be included in the interactive map. FIG. 2 also shows a visual indicator 50 in the form of a circled number 1 on the right upper arm of the patient to indicate the location of the patient's wound. A user can select the visual indicator 50 to add or edit information about the wound, view additional information about the wound, or access additional information about the wound such as x-ray or video images of the wound area, and can select any location on the interactive map to add an annotation at that point on the map or perform actions on the patient using the interactive map. In addition, FIG. 2 shows a table 58 including a first column 60 corresponding to the number in the visual indicator 50, a second column 62 describing the location of the visual indicator 50, and a third column 64 describing the type of wound at visual indicator 50.

The graphical representation preferably provides an interactive map of a human body or part thereof. The interactive maps shown in the drawings are sample interactive maps developed to illustrate the features of the present invention, but the interactive maps could be either general anatomical maps of a generic human body or part thereof or a specific anatomical map of a particular patient's body or part thereof. The health care information system preferably includes a map building tool for creating the graphical representation of the human body or part thereof. The interactive maps provide an intuitive visual illustration of the human body or parts of the human body, and can be either two-dimensional or three-dimensional graphical representations.

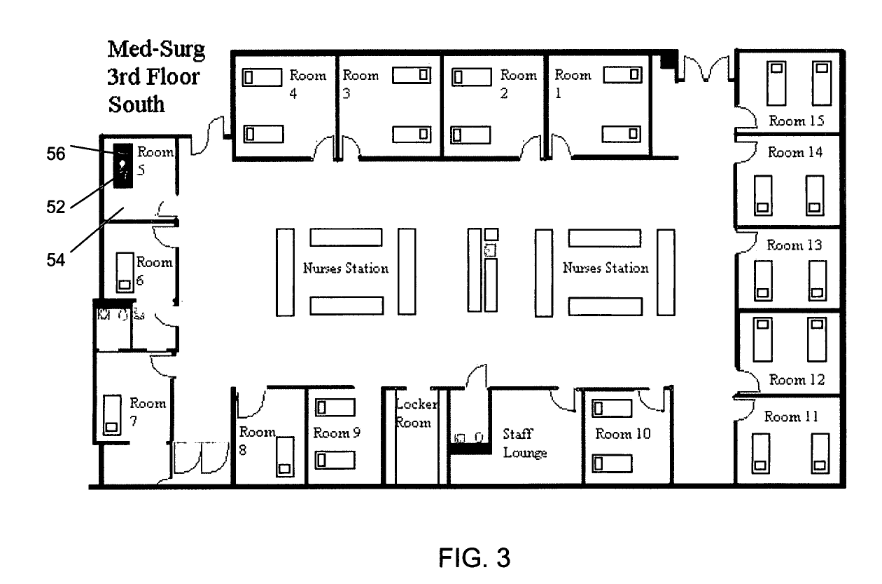

The present invention can also display a graphical representation of an entire health care campus having a number of health care facilities, a single health care facility, a human body or parts of a human body. A user can then select one building or one patient to see an interactive map of that building or patient. For example, FIG. 3 shows an interactive map of a surgical facility in which patient icon 52 is displayed in a bed 56 in a room 54. A user could preferably click on the patient icon 52 and see an interactive map of a human body corresponding to the patient represented by the patient icon 52. Thus, if the patient was in surgery for a severe burn wound to the right upper arm, clicking on that patient icon 52 could display an interactive map of a human body showing a wound on the right upper arm as shown in FIG. 2. Further, clicking on the right upper arm could display a closer view of the arm, or a view of only the wounded area. The graphical representation, therefore, provides an interactive map with “drill down” capabilities. In addition, the graphical representation is preferably configurable and customizable based on the user's or facility's particular needs and preferences.

The health care information system preferably collects statistical data based on actions performed on patients and health care facility resources displayed in the graphical representation of the health care facility. The graphical representation preferably allows a user to display customizable statistics regarding different areas of the health care facility, display customizable statistics regarding patients in the health care facility, and display customizable statistics regarding health care facility resources of the health care facility. For example, the graphical representation allows a user to selectively access, analyze and display patient data. The graphical representation also provides the ability to display patients having common characteristics or features, and display health care facility resources having common characteristics or features. The graphical representation further provides the ability to link or group patients having common characteristics or features and the ability to link or group health care facility resources having common characteristics or features.

The graphical representation can also preferably be used for writing notes and documenting information on the graphical representation for input into patient data or charts, issuing alerts to health care practitioners and other users, directing patients and health care practitioners to their next locations, and seeing where patients have been in the health care facility, including all of the locations in the health care facility the patient has visited. The graphical representation preferably also provides the ability for electronic health record charting of patients, the ability for a user to document information about a patient by writing directly on the graphical representation through the use of a writable display, the ability to display a health care practitioner's schedule and the ability to display the locations of the scheduled appointments or patient visits in the health care facility.

The graphical representation of the present invention is preferably accessible via a web browser for connection to the Internet, an intranet, or other wireless network. For example, users can preferably log in from remote locations as well as in the health care facility. Further, the graphical representation may also include video from video cameras located throughout the health care facility. For example, surgical procedures may be recorded using video cameras, thus the graphical representation could show a user the video recording of a surgical procedure when a user selects a patient or a part of the human body on the graphical representation.

The graphical representation is preferably used for performing actions on patients and health care facility resources displayed in the graphical representation. For example, the graphical representation could be used for, without limitation, documenting information about a patient condition; managing admissions, discharges and transfers of patients within the healthcare facility; admitting patients to the health care facility; assigning patients to rooms and beds of the health care facility; assigning treatment teams to patients; transferring patients within the health care facility; moving patients within the health care facility; swapping patients from one location to another in the health care facility; quarantining off an area for infection control; and discharging patients from the health care facility.

The above actions can preferably be performed using a number of different methods. For example, the actions can preferably be performed by selecting an interactive icon on the graphical representation and selecting an action to be performed, by using a pointing device, by a drag and drop operation, by hovering over an area of the graphical representation, by a right click operation, or by a menu selection operation.

The graphical representation also preferably provides the ability to cause further actions based on actions performed on the interactive map. For example, an action performed on an interactive map, such as a transfer of a patient to a surgical facility, can initiate a notification to a health care practitioner that a patient needs immediate assistance upon arrival at the surgical facility. The notification is preferably in real-time, and can be of a number of different notification types, such as but not limited to an email notification or a pager notification.

A user can preferably obtain information on a displayed patient or patient condition such as a wound by selecting or hovering over visual indicators or icons displayed in the interactive map. In FIG. 2 for example, a user can preferably obtain information on the patient's upper arm wound by selecting or hovering over the visual indicator 50. Preferably, the information can be displayed as a customizable information summary, preferably in the form of a tool tip or other information summary box that appears when a user selects or hovers over the visual indicator 50.

A user may also review patient data, review health care facility resource data, review the chart of the patient, review the status of the patient, perform actions on the patient, or perform actions on health care facility resources.

The graphical representation preferably includes visual indicators to represent certain identifiable and customizable characteristics or status indicators. The visual indicators are preferably customizable icons and customizably color-coded. Visual indicators can be used, for example, to identify patient gender, patient condition, and patient status, as well as wound location as shown in FIG. 2, severity of patient condition such as low-priority, fast-track, and critical, patient age indications, such as pediatric, general, and geriatric, health care facility resources such as mobile and stationary diagnostic equipment, medication carts, and food service. Other icons could also be used to indicate a number of different patient statuses or characteristics. For instance, the visual indicators could identify, without limitation: the confidentiality status of patients; whether a treatment team has been assigned to a patient; the status of patients; the status of health care facility resources; rooms in use; clean rooms; dirty rooms; beds in use; clean beds; dirty beds; the location of patients that have outstanding orders; the location of patients that have overdue tasks; and the location of patients that have overdue medications. The displays are preferably configurable and customizable based upon the user's needs and preferences.

Visual alerts, such as flashing colors or icons, that function to alert users to critical or emergency situations, such as a crashing patient, can also be displayed on the interactive map. The visual alerts include patient status alerts, and health care facility resource alerts. The visual alerts could also identify a number of other patient statuses, including without limitation, patients needing assistance, patients with a pushed call button, patients with outstanding orders, patients with overdue tasks, or patients with overdue medications.

The following description illustrates one example of how the interactive map of the human body or parts thereof could be used in a health care environment. A patient walks into an emergency room with a possibly sprained or broken left ankle. A staff member at the registration desk uses the interactive map to enter the patient's chief complaints. A visual indicator will now be displayed on the anatomical interactive map at the location of the patient's possibly sprained or broken bone, in this case on the patient's left ankle. A nurse on the treatment team then sees the patient and uses the interactive map to review the patient's chief complaint, and enter the patient's vitals and other information relevant to the chief complaint using the interactive map's writable display feature. Alerts could then be issued from the interactive map based on the nurse's actions using a paging or email notification system in communication with the enterprise health care information system. The doctor then sees the patient and uses the interactive map to review the patient's chief complaint, vitals and other relevant information by selecting or hovering over the visual indicator at the left ankle and determines that the patient needs an x-ray for an accurate diagnosis. The interactive map can then be used to order the x-ray, transfer the patient to the radiology department for the x-ray, order any necessary medications for the patient, and make notes on the patient's chart. The radiology staff can then use the interactive map to see where the patient needs an x-ray. Once the x-rays are complete, the visual indicator at the left ankle can be used to access the x-ray images. For instance, the patient may need surgery to repair the sprained or broken ankle. The surgical staff can then use the interactive map to access the x-ray images, or any other images that have been taken of the injured left ankle. The surgical staff can further use the interactive map to record notes before, during and after the surgery. If the surgery is videotaped, users could then access the videotape of the surgery using the interactive map. When the patient is in a recovery room, users could view an interactive map of the health care facility and select the patient in the recovery room to access the interactive map of the human body showing the visual indicator at the left ankle. Information about the patient and the patient's condition could be accessed from the interactive map of the health care facility as well.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

1. A system for providing a comprehensive interactive anatomical graphical representation of a body for use in a health care environment comprising:
a health care information system having at least one data repository for storing patient data, and at least one graphical user interface in communication with the at least one data repository; and
at least one anatomical map of a body stored in the health care information system and displayable by the graphical user interface for managing patient care.

2. The system of claim 1, wherein the health care information system comprises a plurality of integrated software applications and allows users to move between the plurality of software applications.

3. The system of claim 1, wherein the data repository comprises a framework for supporting a plurality of patient care management activities, an enterprise database for storing a universal patient record and security functions, an activities database for storing the activities available in the framework, and an information practitioner for providing each activity with its required data.

4. The system of claim 3, wherein the security functions provide the ability to limit access to patient data displayable in the anatomical graphical representation.

5. The system of claim 3, wherein the security functions provide the ability to enable/disable actions performable on the anatomical graphical representation.

6. The system of claim 1, wherein the anatomical map is two-dimensional.

7. The system of claim 1, wherein the anatomical map is three-dimensional.

8. The system of claim 1, wherein the graphical representation is customizable.

9. The system of claim 1, wherein the graphical representation is configurable.

10. The system of claim 1, wherein the graphical representation provides the ability to display patient data.

11. The system of claim 1, wherein the graphical representation is used for performing actions on the anatomical map displayed in the graphical representation.

12. The system of claim 11, wherein the actions are performed by selecting an interactive icon on the graphical representation and selecting an action to be performed.

13. The system of claim 11, wherein the actions are performed using a pointing device.

14. The system of claim 11, wherein the actions are performed by a drag and drop operation.

15. The system of claim 11, wherein the actions are performed by hovering over an area of the graphical representation.

16. The system of claim 11, wherein the actions are performed by a right click operation.

17. The system of claim 11, wherein the actions are performed by a menu selection operation.

18. The system of claim 1, wherein the graphical representation allows a user to selectively access, analyze and display patient data.

19. The system of claim 1, wherein the graphical representation provides the ability for a user to document information about a patient by writing directly on the graphical representation through the use of a writable display.

20. The system of claim 1, wherein the graphical representation displays a customizable information summary of a patient when a user selects or hovers over an area of the patient's body.

21. The system of claim 1, wherein the graphical representation includes visual indicators to represent certain identifiable and customizable characteristics or status indicators.

22. The system of claim 21, wherein the visual indicators are customizable icons.

23. The system of claim 21, wherein the visual indicators are customizably color-coded.

24. The system of claim 21, wherein the visual indicators are used to identify patient gender, patient condition, and patient status.

25. The system of claim 1, wherein the graphical representation provides the ability to display visual alerts.

26. The system of claim 1, wherein the graphical representation is accessible via a web browser.
